(19) United States
(12) Patent Application Publication
(10) Pub. No.: US 2015/0354358 A1
(43) Pub. Date: Dec. 10, 2015

(54) Post-Peen Grinding of Disk Alloys

(71) Applicant: United Technologies Corporation, (US)

(72) Inventors: Daniel A. Grande, III, West Hartford, CT (US); Andrew L. Haynes, Glastonbury, CT (US); Mario P. Bochiechio, Vernon, CT (US); Darryl Slade Stolz, Newington, CT (US); Isaac L. Han, Hartford, CT (US)

(73) Assignee: United Technologies Corporation, Hartford, CT (US)

(21) Appl. No.: 13/724,532

(22) Filed: Dec. 21, 2012

(51) Int. Cl. F01D 5/02; C22C 19/05; B22F 3/24; F01D 5/28; C22F 1/10

(52) U.S. Cl. CPC F01D 5/02; F01D 5/28; C22F 1/10; B22F 3/24; C22C 19/057; C22C 19/056; C22C 19/055; F05D 2220/3219; F05D 2230/22; F05D 2230/14; F05D 2230/25; F05D 2230/411; F05D 2300/175; B22F 2003/248

(57) ABSTRACT

A process for forming a metallic article comprises: peening a precursor to create a residual stress distribution and a region of slip bands; and surface machining the precursor to substantially remove the slip band region while leaving a substantial amount of the residual stress distribution.

### BACKGROUND

The disclosure relates to powder metallurgical (PM) nickel-base superalloys. More particularly, the disclosure relates to such superalloys used in high-temperature gas turbine engine components such as turbine disks and compressor disks.

The combustion, turbine, and exhaust sections of gas turbine engines are subject to extreme heating as are latter portions of the compressor section. This heating imposes substantial material constraints on components of these sections. One area of particular importance involves blade-bearing turbine disks. The disks are subject to extreme mechanical stresses, in addition to the thermal stresses, for significant periods of time during engine operation.

Exotic materials have been developed to address the demands of turbine disk use. U.S. Pat. No. 6,521,175 (the '175 patent) discloses an advanced nickel-base superalloy for powder metallurgical (PM) manufacture of turbine disks. The disclosure of the '175 patent is incorporated by reference herein as if set forth at length. The '175 patent discloses disk alloys optimized for short-time engine cycles, with disk temperatures approaching temperatures of about 1500° F. (816° C.) US20100008790 (the '790 publication) discloses a nickel-base disk alloy having a relatively high concentration of tantalum coexisting with a relatively high concentration of one or more other components. U.S. patent application Ser. No. 13/372,585 filed Feb. 14, 2012 discloses a more recent alloy. Other disk alloys are disclosed in U.S. Pat. No. 5,104,614, U.S. Pat. No. 5,662,749, U.S. Pat. No. 6,908,519, EP1201777, and EP1195446.

In an exemplary PM process, the powdered alloy is compacted into an initial precursor (compact) having basic disk shape. The compact may be forged to form a forging. The forging may then be machined to clean up features or define features (e.g., disk slots for blade root retention). The forged/machined precursor may be heat treated to precipitation harden to increase strength to optimize overall mechanical strength. A peening process may then impart a compressive residual stress to prevent fatigue initiation on the surface (particularly in high-fatigue areas).

Post-peening material removal has been proposed for specific purposes on specific articles. U.S. Pat. No. 4,454,740 identifies polishing to smooth an airfoil in the gaspath of an engine. JP63052729A identifies improving fatigue resistance of a steel coil spring by electrolytic grinding or chemical grinding after a shot-peening treatment.

### SUMMARY

One aspect of the disclosure involves a process for forming a metallic article comprising: peening a precursor to create a residual stress distribution and a region of slip bands; and surface machining the precursor to substantially remove the slip band region while leaving a substantial amount of the residual stress distribution.

In additional or alternative embodiments of any of the foregoing embodiments, the surface machining comprises abrasive grinding.

In additional or alternative embodiments of any of the foregoing embodiments, the surface machining does not entirely remove a residual stress distribution of the peening.

In additional or alternative embodiments of any of the foregoing embodiments, the surface machining comprises removing a depth of 30-120 micrometer.

In additional or alternative embodiments of any of the foregoing embodiments, the process further comprises forming the precursor by: compacting a powder; forging the compacted powder; and machining the forged compacted powder.

In additional or alternative embodiments of any of the foregoing embodiments, the powder is ASTM 4-8 (91 μm-22 μm average diameter).

In additional or alternative embodiments of any of the foregoing embodiments, a depth of the residual stress distribution is 160 μm-300 μm;

In additional or alternative embodiments of any of the foregoing embodiments, the slip band region extends 30 μm-60 μm deep; and

In additional or alternative embodiments of any of the foregoing embodiments, the removing removes the entire slip band region.

In additional or alternative embodiments of any of the foregoing embodiments, the surface machining comprises abrasive grinding.

In additional or alternative embodiments of any of the foregoing embodiments, the process of claim 1 further comprises: heat treating the precursor, at least one of before and after the machining, by heating to a temperature of no more than 1232° C. (2250° F.)

In additional or alternative embodiments of any of the foregoing embodiments, the process further comprises: heat treating the precursor, at least one of before and after the machining, the heat treating effective to increase a characteristic γ grain size from a first value of about 10 μm or less to a second value of 20-120 μm.

In additional or alternative embodiments of any of the foregoing embodiments, there is no peening after the machining.

In additional or alternative embodiments of any of the foregoing embodiments, the article is a gas turbine engine turbine or compressor disk.

In additional or alternative embodiments of any of the foregoing embodiments, the peening and surface machining are over a majority of a non-gaspath surface area of the disk.

In additional or alternative embodiments of any of the foregoing embodiments, the peening and surface machining are at least over a rim fore and aft surface area of the disk.

In additional or alternative embodiments of any of the foregoing embodiments, the article comprises a nickel-based superalloy.

Another aspect of the disclosure involves a powder metallurgical article formed by the process.

In additional or alternative embodiments of any of the foregoing embodiments, the powder metallurgical article has an alloy comprising, in weight percent: a content of nickel as a largest content; 0.2 to 5.1 aluminum; 0.0 to 0.35 boron; 0.01 to 0.35 carbon; 9.0 to 29.5 chromium; 0.0 to 27.0 cobalt; 1.1 to 14.5 molybdenum; 0.0 to 5.1 niobium; 0.0 to 2.5 tantalum; 0.2 to 9.95 titanium; 0.0 to 14.0 tungsten; 0.02 to 0.24 zirconium; 0.00 to 1.4 hafnium; 0.00 to 1.5 yttrium; 0.00 to 1.5 vanadium; and 0.0 to 40.0 iron.

In additional or alternative embodiments of any of the foregoing embodiments, the powder metallurgical article has an alloy comprising, in weight percent: a content of nickel as a largest content; 2.10 to 5.0 aluminum; 0.01 to 0.09 boron; 0.02 to 0.15 carbon; 9.5 to 16.00 chromium; 8.0 to 22.0 cobalt; 2.8 to 4.75 molybdenum; 0.0 to 3.5 niobium; 1.75 to 6.1 tantalum; 2.5 to 4.3 titanium; 0.0 to 4.0 tungsten; 0.0 to 0.09 zirconium; and 0.0 to 1.4 hafnium.

In additional or alternative embodiments of any of the foregoing embodiments, the powder metallurgical article has an alloy comprising, in weight percent: a content of nickel as a largest content; 3.25 to 3.75 aluminum; 0.02 to 0.09 boron; 0.02 to 0.09 carbon; 9.5 to 11.25 chromium; 16.0 to 22.0 cobalt; 2.8 to 4.2 molybdenum; 1.6 to 2.4 niobium; 4.2 to 6.1 tantalum; 2.6 to 3.5 titanium; 1.8 to 2.5 tungsten; and 0.04 to 0.09 zirconium, with only up to trace amounts of other elements if any.

Another aspect of the disclosure involves a gas turbine engine disk comprising: a powder metallurgical nickel-based metallic substrate having: a surface; and a residual compressive stress distribution below the surface and having a depth of at least 0.03 mm and a magnitude of at least 75 ksi, wherein there is no slip band region along a region having said residual compressive stress distribution.

In additional or alternative embodiments of any of the foregoing embodiments, said region includes fore and aft surfaces of a rim portion of the disk.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is an exploded partial view of a gas turbine engine turbine disk assembly.

FIG. 2 is a flowchart of a process for preparing a disk of the assembly of FIG. 1.

FIG. 3 is a plot illustrating post-peen cycle fatigue plotting stress against cycles-to-failure for a post-peen surface ground specimen against comparative data from unpeened and peened material.

FIG. 4 is an electron backscatter diffraction (EBSD) image quality map showing sectional microstructural damage in the form of slip bands.

FIG. 5 is a sectional photomicrograph of tested fatigue specimen showing slip bands running parallel to secondary cracks and showing the crystallographic nature of both.

FIG. 5A is an enlarged view of the specimen of FIG. 5.

FIG. 6 is a secondary scanning electron microscope (SEM) image of failure origin in a post-peen surface-ground specimen

FIG. 7 is a backscatter SEM image showing failure origin in a post-peen surface-ground specimen.

FIG. 8 is an X-ray diffraction (XRD) plot showing post-peen stress vs. depth.

Like reference numbers and designations in the various drawings indicate like elements.

### DETAILED DESCRIPTION

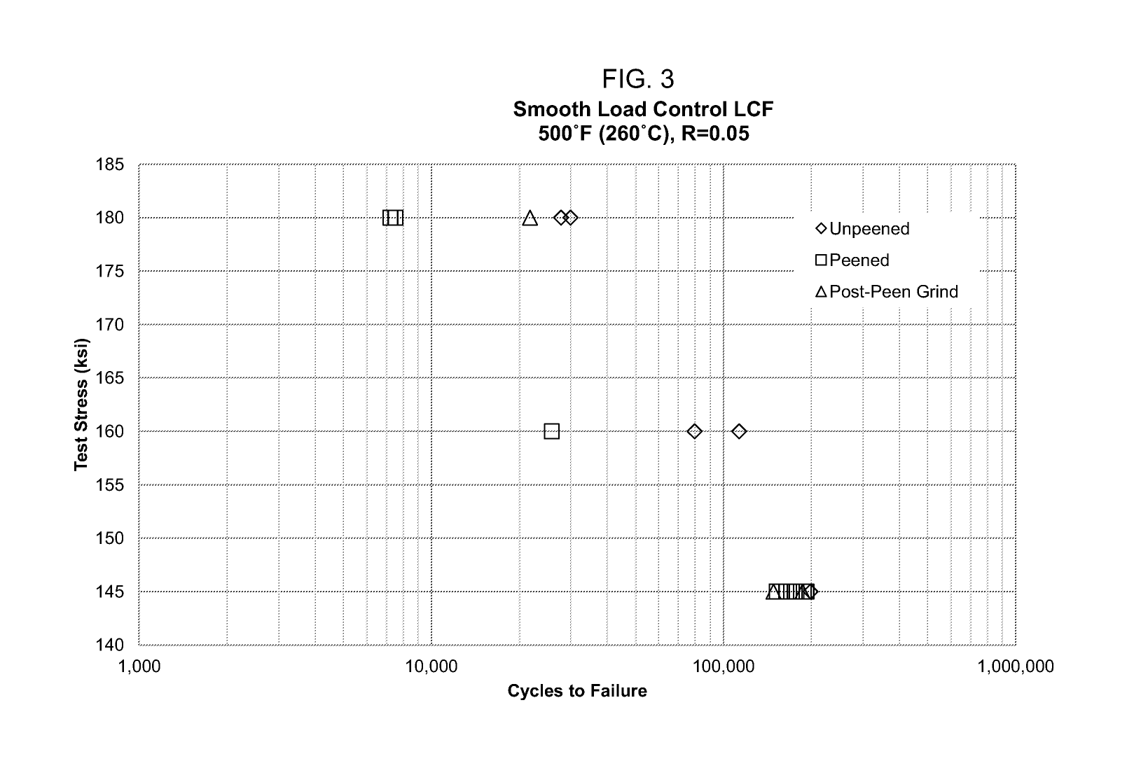

In testing a PM disk alloy, a shot peen fatigue debit has been observed when tested above yield strength. For example, FIG. 3 shows data from tests described in detail further below. However, it is quickly seen that the peened material has a substantial loss of fatigue life relative to unpeened material. The root cause of this debit was first believed (see further discussion below) to be the formation of microstructural damage, in the form of slip bands, during the shot peening process. Slip bands are precursors to fatigue cracks and their presence significantly reduces the life of the material. We believe this is a phenomenon in coarse grain (CG) alloys (e.g., ASTM 4-8 (91 μm-22 μm average diameter) for powder metal alloys; in contrast, fine grain is defined as ASTM 10 or finer (11 μm or smaller average diameter).

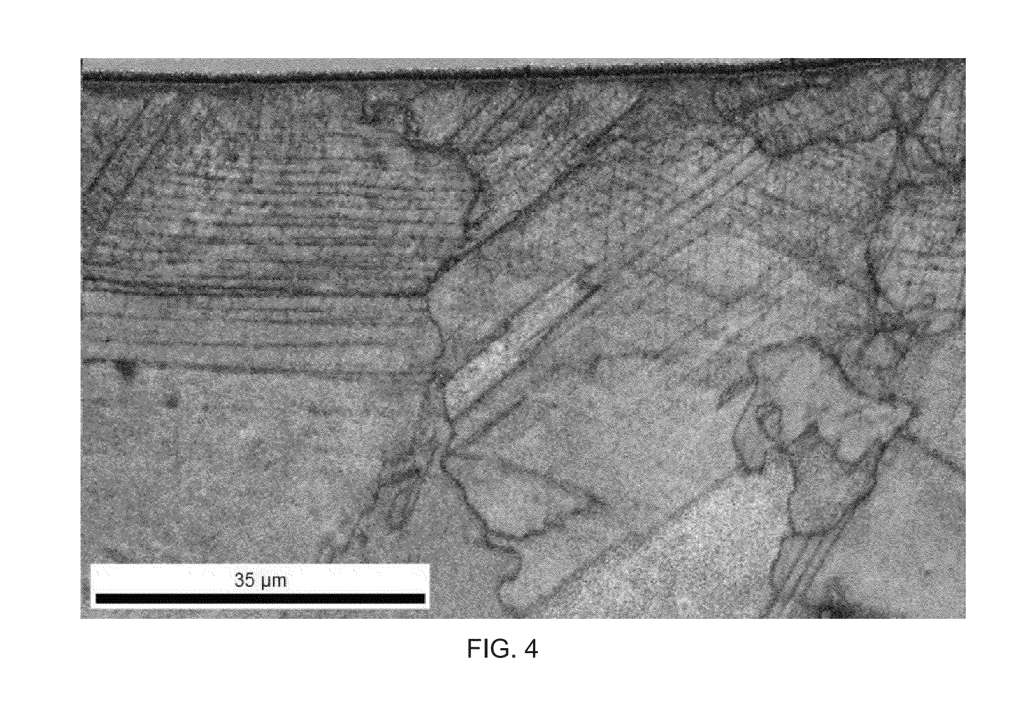

FIG. 4 shows a peened substrate having microstructural damage concentrated near the surface and in the form of groups of parallel slip bands.

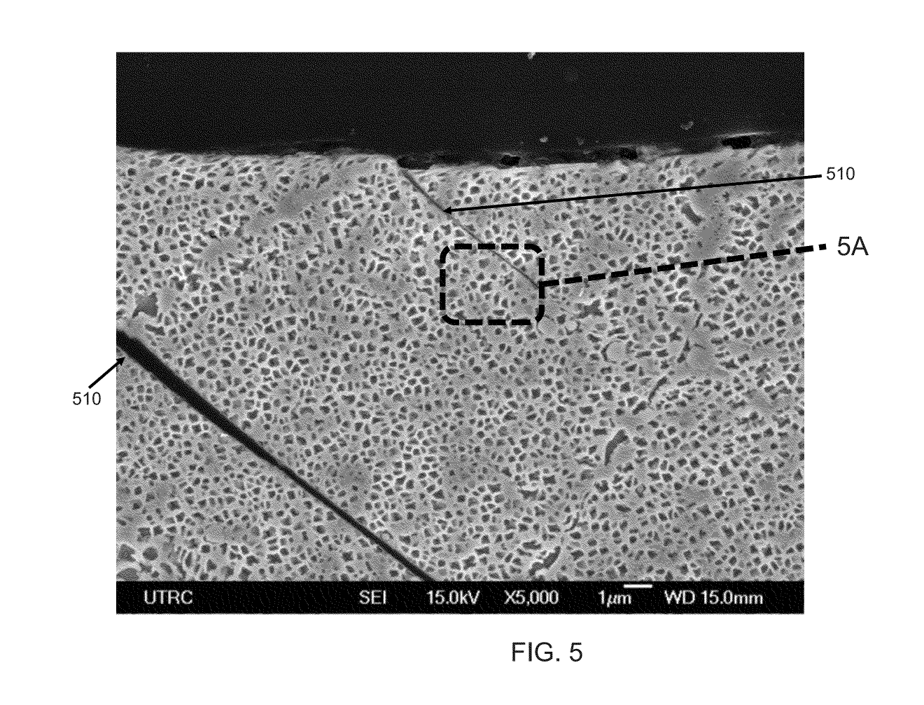

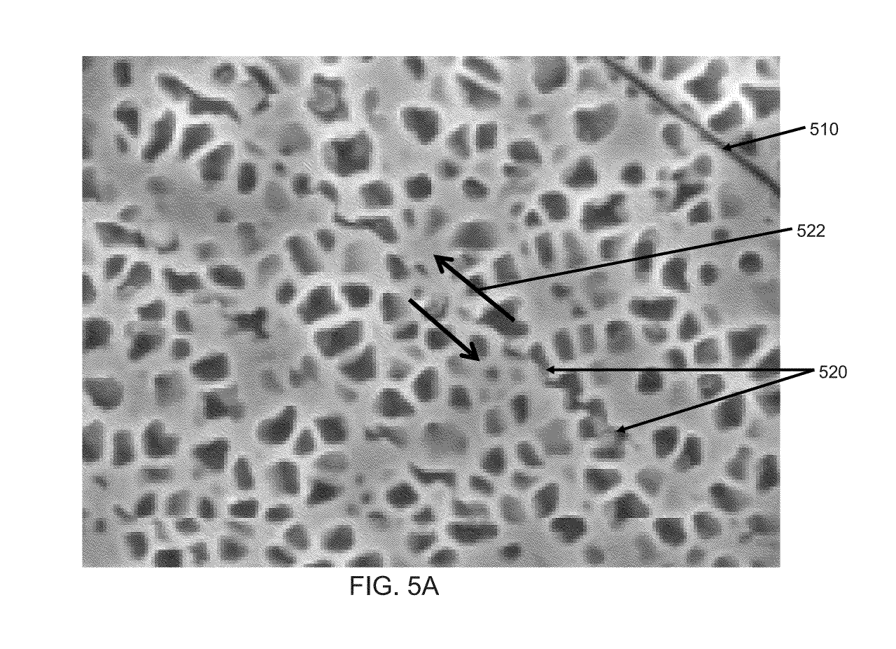

FIGS. 5 and 5A show such material after fatigue testing. Cracks are seen as 510. FIG. 5A further shows the cracks 510 as being parallel to the slip bands 520. The slip bands are characterized by sheared γ′ particles with the opposed shearing directions being shown as 522 on either side of the associated slip band.

In FIG. 4, it is seen that the slip bands are concentrated in approximately the first 40 micrometers of thickness with great attenuation in slip band density in the next 40 micrometers.

Peening is typically one of the last surface processes an alloy will see before it is ready for service. However, we suggest that after the peening process has been completed, a thin layer of material (e.g., 0.003 inch (0.08 mm)) be removed to remove slip bands. In the exemplary FIG. 4 situation such amount of removal will substantially remove the entire slip band region. A more broad range of removal of such material might be 30-120 micrometers, more narrowly, 50-100 micrometers. This removal may be done with traditional grinding processes (e.g., abrasive grinding wheel(s); other material removal techniques, such as lathe turning and electrochemical material removal techniques may be suited for particular physical situations). By removing material post-peening, the slip band damage is removed. The beneficial residual stress layer created by the peening process substantially remains (e.g., at least about a third or a half remains). Thus, below yield strength, there is still a fatigue credit relative to un-peened material.

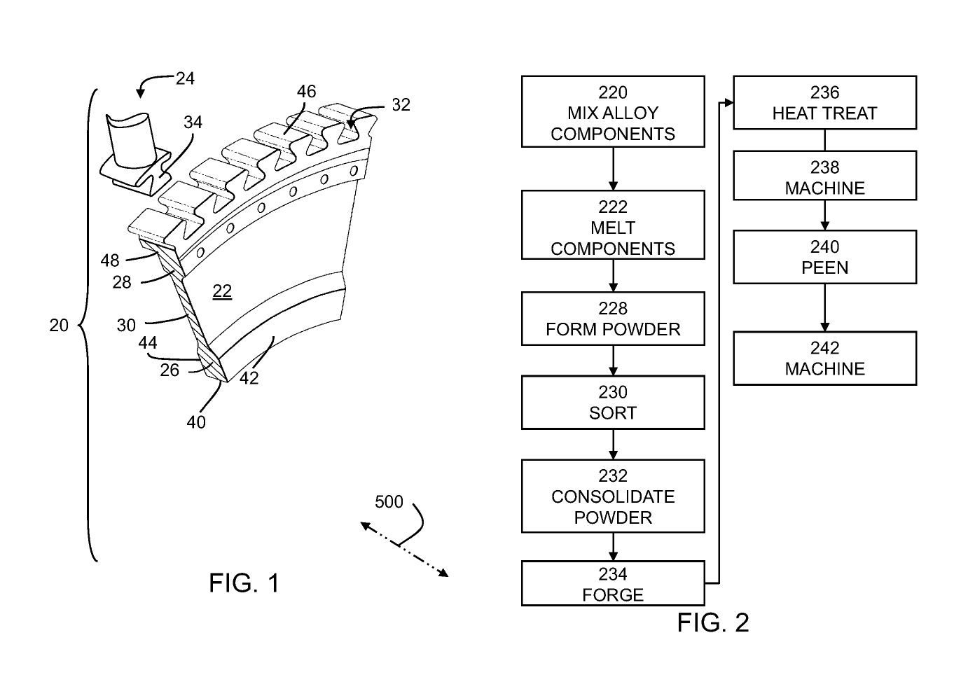

FIG. 1 shows a gas turbine engine disk assembly 20 including a disk 22 and a plurality of blades 24. The disk is generally annular, extending from an inboard bore or hub 26 at a central aperture to an outboard rim 28. A relatively thin web 30 is radially between the bore 26 and rim 28. The periphery of the rim 28 has a circumferential array of engagement features 32 (e.g., dovetail slots) for engaging complementary features 34 of the blades 24. In other embodiments, the disk and blades may be a unitary structure (e.g., so-called “integrally bladed” rotors or disks). FIG. 1 further shows bore inner diameter (ID) surface 40, disk fore/front surface 42 and aft/rear surface 44, and rim outer diameter (OD) surface 46.

The disk 22 may be formed by a powder metallurgical forging process (e.g., as is disclosed in U.S. Pat. No. 6,521,175). FIG. 2 shows an exemplary process. The elemental components of the alloy are mixed (e.g., as individual components of refined purity or alloys thereof). The mixture is melted sufficiently to eliminate component segregation. The melted mixture is atomized to form droplets of molten metal. The atomized droplets are cooled to solidify into powder particles. The powder may be screened to restrict the ranges of powder particle sizes allowed. The powder is put into a container. The container of powder is consolidated in a multi-step process involving compression and heating. The resulting consolidated powder then has essentially the full density of the alloy without the chemical segregation typical of larger castings. A blank of the consolidated powder may be forged at appropriate temperatures and deformation constraints to provide a forging with the basic disk profile. The forging is then heat treated in a multi-step process involving high temperature heating followed by a rapid cooling process or quench. The heat treatment may increase the characteristic gamma (γ) grain size from an exemplary 10 μm or less to an exemplary 20-120 μm (with 30-60 μm being preferred). The quench for the heat treatment may also form strengthening precipitates (e.g., gamma prime (γ′) and eta (η) phases discussed in further detail below) of a desired distribution of sizes and desired volume percentages. Subsequent heat treatments may be used to modify these distributions to produce the requisite mechanical properties of the manufactured forging. The increased grain size is associated with good high-temperature creep-resistance and decreased rate of crack growth during the service of the manufactured forging. The heat treated forging may be then subject to machining of the final profile and the slots.

A post-machining peening (e.g., shot peening) may then be performed. This generally serves to impart (at least to the critical fatigue areas) a compressive residual stress to prevent fatigue initiation.

It has now been observed that an additional post-peening surface grinding/machining may have beneficial results. This may substantially remove the slip band region while leaving a substantial residual stress distribution. The removal may target high temperature/high stress locations. This is because these locations are more likely to creep relax. Creep relaxation will cause a relaxation in residual stresses. Without the beneficial residual compressive stress layer, the slip bands are subject to net tensile stresses which may initiate cracking. As precursors to LCF cracks, the exposed slip bands would have a negative impact on fatigue life. For example, on a disk this may be most significant along the web or rim (fore, aft and/or OD surfaces), namely notch locations (e.g., 48 in FIG. 1, between wider and narrower portions of the rim section). Locations nearer the OD generally see higher temperatures, and the stresses in notch locations are generally higher. Therefore they are the locations most likely to lose the beneficial compressive stress due to creep relaxation

The slip bands penetrate approximately 30 μm to 60 μm into the exemplary material. Compressive residual stress penetrates approximately 160 μm into the material. Therefore, the largest machining range between those two exemplary values, to remove slip bands but retain compressive residual stress, would be about 45 μm-160 μm. In that example, 70 μm-90 μm removal provides a margin in removing all slip bands but leaving as much residual stress layer as possible.

Tests were performed on an alloy having the nominal composition disclosed in U.S. patent application Ser. No. 13/372,585, entitled “Superalloy Compositions, Articles, and Methods of Manufacture”, filed Feb. 14, 2012, the disclosure of which is incorporated by reference in its entirety herein as if set forth at length. This material may be characterized by weight percentage as nickel base composition of matter having a content of nickel as a largest content; 3.10 to 3.75 aluminum; 0.02 to 0.09 boron; 0.02 to 0.09 carbon; 9.5 to 11.25 chromium; 20.0 to 22.0 cobalt; 2.8 to 4.2 molybdenum; 1.6 to 2.4 niobium; 4.2 to 6.1 tantalum; 2.6 to 3.5 titanium; 1.8 to 2.5 tungsten; and 0.04 to 0.09 zirconium.

Basic alloy preparation involved the methods described above.

An exemplary tested heat treatment is a three-heat process with intervening cooling. First is a solution heat treatment. Second is stabilization heat treatment. Third is precipitation heat treatment. Examples of such treatment are found in U.S. Ser. No. 13/372,585.

Peening was performed on some of the heat treated specimens. Exemplary peening involved SAE110 size (0.011 inch (0.28 mm)) cast steel shot peened at Almen 6A intensity (0.006 inch (0.15 mm) deflection in a standard Almen strip).

Post-peen grinding was performed on some of the peened specimens by abrasive wheel grinding. The post-peen grinding process removed 0.003 inch (76 micrometers) of material.

It is visible in FIG. 3 that post-peen grinding shows an improvement over as-peened specimens in a higher stress domain region of low cycle fatigue (e.g., loads causing failures of peened but unground material at less than 50,000 cycles, more particularly about 1000 cycles) while not producing any significant debit at a lower stress domain of LCF (e.g., loads causing failures of the unground or ground material in the range of 100,000+ cycles). This is most likely not only due to the removal of slip bands in and of itself. Instead, this improvement is believed partially caused by a reduction in the residual stress layer during the material removal procedure. We have observed that at stresses over yield strength there is an inversion with the compressive stress becoming tensile. The slightly reduced compressive stress left after slip band removal (thus similarly reduced tensile stress upon inversion) along with the reduced initiation sites associated with slip band removal forestalls failure.

However, this post-peen grinding process still removes microstructural damage in the form of slip bands. Slip band removal may have intrinsic benefits. If there was ever to be a relaxation of residual stresses in a part (e.g., due to creep relaxation or stresses above yield strength), and the part had exposed slip bands, the slip bands would present crack initiation sites increasing risk of cracking. The post-peen grinding mitigates that risk by removing slip bands.

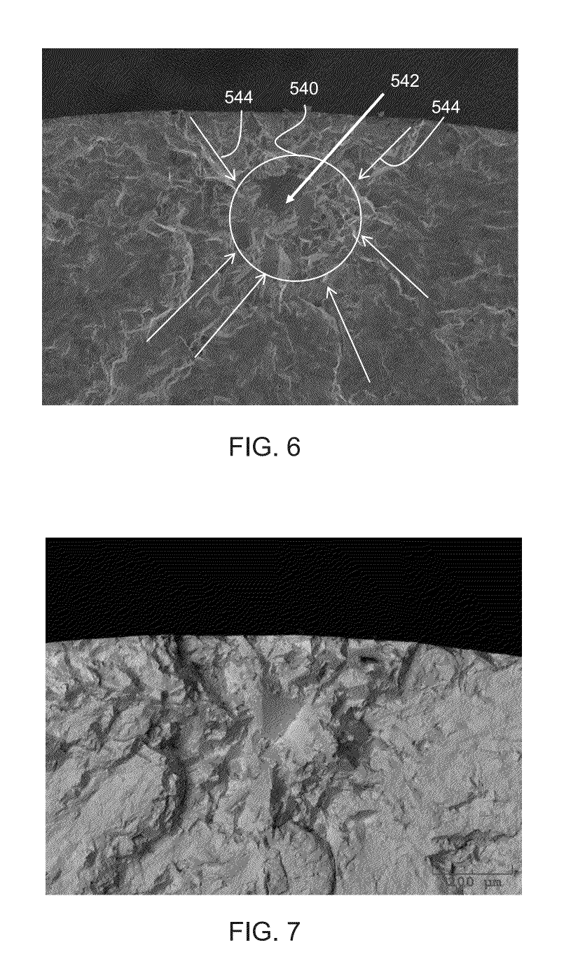

FIGS. 6 and 7 are fractography of post-peen machined specimens tested below yield strength. A circle 540 highlights the failure origin from a large subsurface grain facet 542. Subsurface failure origin is evidenced by fatigue striations (also known as river lines) 544 that point to the grain facet 542. This indicates that a compressive residual stress layer remains after the post peen grinding.

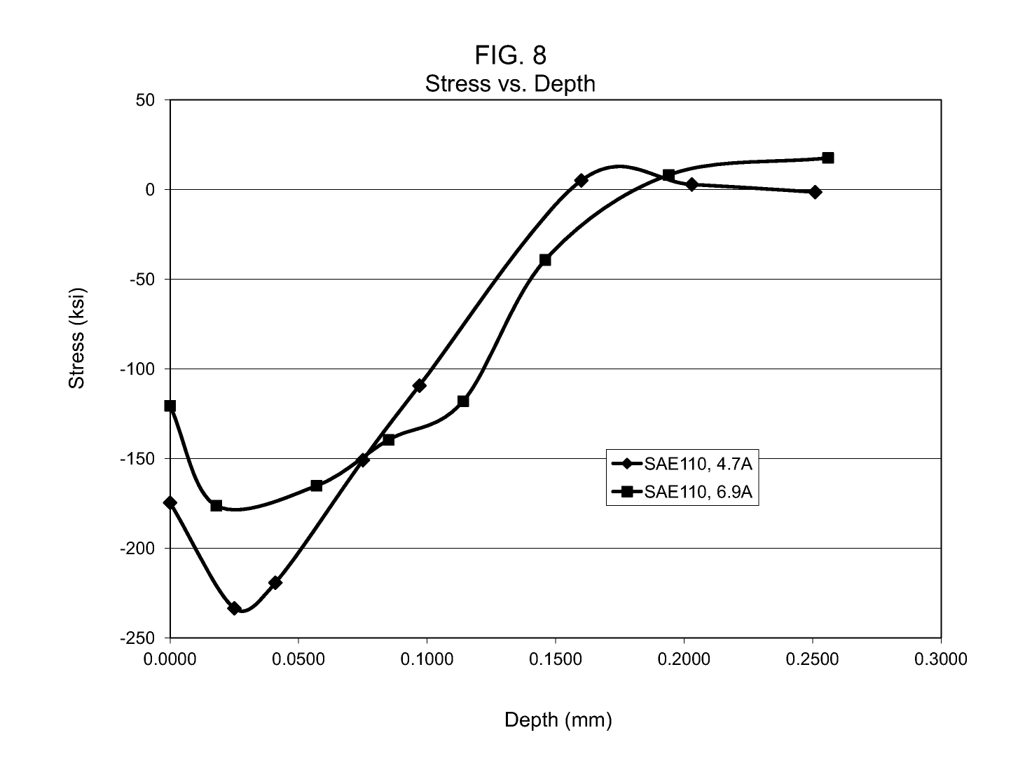

FIG. 8 shows a pair of post-peen, pre-grind exemplary stress distributions. Very near the surface, the magnitude of the distribution quickly progressively increases, reaching a peak below 0.05 mm and then progressively decreases to essentially zero at a location in the vicinity of 0.15-0.20 mm deep. Removing the exemplary depth of slip band region thus still leaves a considerable region of compressive stress (although there will be slight relaxation very near the final surface).

Although a particular alloy was tested, benefits would be expected in a range of alloys. An exemplary broad range of nickel-base superalloys may comprise, consist essentially of, or consist of, in weight percent, a content of nickel as a largest content; 0.2 to 5.1 aluminum; 0.0 to 0.35 boron; 0.01 to 0.35 carbon; 9.0 to 29.5 chromium; 0.0 to 27.0 cobalt; 1.1 to 14.5 molybdenum; 0.0 to 5.1 niobium; 0.0 to 2.5 tantalum; 0.2 to 9.95 titanium; 0.0 to 14.0 tungsten; and 0.02 to 0.24 zirconium; 0.00 to 1.4 hafnium; 0.00 to 1.5 yttrium; 0.00 to 1.5 vanadium; and 0.0 to 40.0 iron.

Alternatively, a family of such alloys may comprise, consist essentially of, or consist of, in weight percent, a content of nickel as a largest content; 2.10 to 5.0 aluminum; 0.01 to 0.09 boron; 0.02 to 0.15 carbon; 9.5 to 16.00 chromium; 8.0 to 22.0 cobalt; 2.8 to 4.75 molybdenum; 0.0 to 3.5 niobium; 1.75 to 6.1 tantalum; 2.5 to 4.3 titanium; 0.0 to 4.0 tungsten; 0.0 to 0.09 zirconium; and 0.0 to 1.4 hafnium. In some such embodiments, there would be only up to trace amounts of other elements if any. Such trace amounts would be those that do not adversely affect material properties and would be expected to aggregate no more than 1.5 weight percent and represent less than 1.0 weight percent of any single element.

Alternatively, a generally more specific family of such alloys may comprise, consist essentially of, or consist of, in weight percent a content of nickel as a largest content; 3.25 to 3.75 aluminum; 0.02 to 0.09 boron; 0.02 to 0.09 carbon; 9.5 to 11.25 chromium; 16.0 to 22.0 cobalt; 2.8 to 4.2 molybdenum; 1.6 to 2.4 niobium; 4.2 to 6.1 tantalum; 2.6 to 3.5 titanium; 1.8 to 2.5 tungsten; and 0.04 to 0.09 zirconium, with only up to trace amounts of other elements if any. Such trace amounts would be those that do not adversely affect material properties and would be expected to aggregate no more than 1.5 weight percent and represent less than 1.0 weight percent of any single element (much lower for elements such as hafnium).

One or more embodiments have been described. Nevertheless, it will be understood that various modifications may be made. For example, the operational requirements of any particular engine will influence the manufacture of its components. As noted above, the principles may be applied to the manufacture of other components such as impellers, shaft members (e.g., shaft hub structures), and the like. Accordingly, other embodiments are within the scope of the following claims.

1. A process for forming a metallic article comprising:
peening a precursor to create a residual stress distribution and a region of slip bands; and
surface machining the precursor to substantially remove the slip band region while leaving a substantial amount of the residual stress distribution.

2. The process of claim 1 wherein:
the surface machining comprises abrasive grinding.

3. The process of claim 1 wherein:
the surface machining does not entirely remove a residual stress distribution of the peening.

4. The process of claim 1 wherein:
the surface machining comprises removing a depth of 30-120 micrometer.

5. The process of claim 1 further comprising forming the precursor by:
compacting a powder;
forging the compacted powder; and
machining the forged compacted powder.

6. The process of claim 1 wherein:
the powder is ASTM 4-8 (91 μm-22 μm average diameter).

7. The process of claim 1 wherein:
a depth of the residual stress distribution is 160 μm-300 μm;
the slip band region extends 30 μm-60 μm deep; and
the removing removes the entire slip band region.

8. The process of claim 7 wherein:
the surface machining comprises abrasive grinding.

9. The process of claim 1 further comprising:
heat treating the precursor, at least one of before and after the surface machining, by heating to a temperature of no more than 1232° C. (2250° F.)

10. The process of claim 1 further comprising:
heat treating the precursor, at least one of before and after the surface machining, the heat treating effective to increase a characteristic γ grain size from a first value of about 10 μm or less to a second value of 20-120 μm.

11. The process of claim 1 wherein:
there is no peening after the surface machining.

12. The process of claim 1 wherein:
the article is a gas turbine engine turbine or compressor disk.

13. The process of claim 12 wherein:
the peening and surface machining are over a majority of a non-gaspath surface area of the disk.

14. The process of claim 12 wherein:
the peening and surface machining are at least over a rim fore and aft surface area of the disk.

15. The process of claim 1 wherein:
the article comprises a nickel-based superalloy.

16. A powder metallurgical article formed by the process of claim 1.

17. The powder metallurgical article of claim 16 having an alloy comprising, in weight percent:
a content of nickel as a largest content;
0.2 to 5.1 aluminum;
0.0 to 0.35 boron;
0.01 to 0.35 carbon;
9.0 to 29.5 chromium;
0.0 to 27.0 cobalt;
1.1 to 14.5 molybdenum;
0.0 to 5.1 niobium;
0.0 to 2.5 tantalum;
0.2 to 9.95 titanium;
0.0 to 14.0 tungsten; and
0.02 to 0.24 zirconium;
0.00 to 1.4 hafnium;
0.00 to 1.5 yttrium;
0.00 to 1.5 vanadium; and
0.0 to 40.0 iron.

18. The powder metallurgical article of claim 16 having an alloy comprising, in weight percent:
a content of nickel as a largest content;
2.10 to 5.0 aluminum;
0.01 to 0.09 boron;
0.02 to 0.15 carbon;
9.5 to 16.00 chromium;
8.0 to 22.0 cobalt;
2.8 to 4.75 molybdenum;
0.0 to 3.5 niobium;
1.75 to 6.1 tantalum;
2.5 to 4.3 titanium;
0.0 to 4.0 tungsten;
0.0 to 0.09 zirconium; and
0.0 to 1.4 hafnium.

19. The powder metallurgical article of claim 16 having an alloy comprising, in weight percent:
a content of nickel as a largest content;
3.25 to 3.75 aluminum;
0.02 to 0.09 boron;
0.02 to 0.09 carbon;
9.5 to 11.25 chromium;
16.0 to 22.0 cobalt;
2.8 to 4.2 molybdenum;
1.6 to 2.4 niobium;
4.2 to 6.1 tantalum;
2.6 to 3.5 titanium;
1.8 to 2.5 tungsten; and
0.04 to 0.09 zirconium, with only up to trace amounts of other elements if any.

20. A gas turbine engine disk comprising:
a powder metallurgical nickel-based metallic substrate having:
a surface; and
a residual compressive stress distribution below the surface and having a depth of at least 0.03 mm and a magnitude of at least 75 ksi,
wherein:
there is no slip band region along a region having said residual compressive stress distribution.

21. The disk of claim 20 wherein:
said region includes fore and aft surfaces of a rim portion of the disk.
